(19) United States
(12) Patent Application Publication
(10) Pub. No.: US 2013/0117251 A1
(43) Pub. Date: May 9, 2013

(54) CENTRAL SERVER, PROXY SERVER ARRANGEMENT FOR USE IN THE DISTRIBUTION OF INFORMATION ON THE INTERNET

(71) Applicants: Adam Archer Fisk, Los Angeles, CA (US); Richard Mark Friedhoff, San Francisco, CA (US)

(72) Inventors: Adam Archer Fisk, Los Angeles, CA (US); Richard Mark Friedhoff, San Francisco, CA (US)

(21) Appl. No.: 13/729,912

(22) Filed: Dec. 28, 2012

Related U.S. Application Data
(63) Continuation of application No. 13/451,222, filed on Apr. 19, 2012, now abandoned.
Application No. 13/451,222 is a continuation of application No. 12/802,398, filed on Jun. 7, 2010, now abandoned.

(51) Int. Cl. G06F 17/30

(52) U.S. Cl. CPC G06F 17/30864
USPC 707/707

(57) ABSTRACT

In an exemplary embodiment of the present invention, a proxy server comprising a computer program product is provided. According to a feature of the present invention, the computer program product is disposed on a computer readable media, and the product includes computer executable process steps operable to control a computer to: implement a proxy server operable to receive a rule protocol for modification of information received via the Internet, according to instructions caused by an entity that generates content related to the information, and to modify content by the proxy server, of information received via the Internet, according to the rule protocol.

This is a Continuation of U.S. patent application Ser. No. 13/451,222, filed Apr. 19, 2012, which is a Continuation of U.S. patent application Ser. No. 12/802,398, filed Jun. 7, 2010, both of which are hereby incorporated by reference herein.

### BACKGROUND OF THE INVENTION

Internet technology provides a highly efficient and effective system for the distribution of information. For example, a user can insert a search request, including a term or terms describing a subject of interest to the user, in a search engine, and initiate a search. The search engine typically returns a list of web sites relevant to the terms of the search request. The search engine also returns sponsored links and other information.

A sponsored link is a link to a web site of an individual or organization that pays a fee to the search engine operator to list a link to a designated web site when a search request indicates subject matter relevant to the designated web site. Thus, the sponsor can assure user traffic from users expressing an interest in subject matter relevant to the sponsor's web site. The other information can include advertisements for goods and services that are also relevant to the terms of the search request. Again, the advertisements are distributed by the operator of the search engine for a fee paid by the sponsor of the advertisement.

An operator of a search engine can also acquire detailed information on users utilizing the search engine to compile user profiles, demographic information and other user statistics. In this manner, the search engine operator can fine tune information distribution to an audience that is accurately targeted in terms of interest to the content of the distributed information.

Thus, the current technological arrangement of the Internet provides unique control opportunities to search engine operators in the distribution of information specifically directed to users most likely to be interested in the information. The economic benefit of the control also flows to the search engine operator in the form of the fees paid by sponsors. However, the greatest benefit to the user is the list of web sites returned in response to the user's search request. The list often includes the web sites of newspaper and magazine publishers and other content providers. These publishers and content providers expend considerable amounts of economic resources to acquire and organize the information displayed on the web sites, but are left out of the control loop for and economic benefit of targeted information distribution.

### SUMMARY OF THE INVENTION

The present invention provides a method and system for controlling distribution of information on the Internet, in a manner such that control of information distribution is exercised by an entity such as any individual or organization that generates content related to the distributed information.

In a first exemplary embodiment of the present invention, a proxy server comprising a computer program product is provided. According to a feature of the present invention, the computer program product is disposed on a computer readable media, and the product includes computer executable process steps operable to control a computer to: implement a proxy server operable to receive a rule protocol for modification of information received via the Internet, according to instructions caused by an entity that generates content related to the information, and to modify content by the proxy server, of information received via the Internet, according to the rule protocol.

According to a feature of the first exemplary embodiment of the present invention, the modification of information includes sponsored links and advertisements provided on behalf of the entity that generates content.

In a second exemplary embodiment of the present invention a central server comprising a computer program product is provided. According to a feature of the present invention, the computer program product is disposed on a computer readable media, and the product includes computer executable process steps operable to control a computer to: implement a central server operable to receive data from a user, generate and transmit to the user a rule protocol for modification of content of information received by the user via the Internet, the rule protocol being generated as a function of the data from the user and information from a content provider.

In a third exemplary embodiment of the present invention, a proxy server comprising a computer program product is provided. According to a feature of the present invention, the computer program product is disposed on a computer readable media, and the product includes computer executable process steps operable to control a computer to: implement a proxy server operable to receive a rule protocol for assisting a user web browser by controlling information received by the web browser via the Internet, according to instructions caused by an entity that generates content related to the information.

In a fourth exemplary embodiment of the present invention, a computer program product is provided. According to a feature of the present invention, the computer program product is disposed on a computer readable media, the product including computer executable process steps operable to control a computer to: cause content of a web site maintained by an entity that generates content, to be modified as a function of information based upon user data and information related to the entity that generates content, the computer readable media being adapted for execution in connection with a web browser of an individual user.

In a fifth exemplary embodiment of the present invention, a central server comprising a computer program product is provided. According to a feature of the present invention, the computer program product is disposed on a computer readable media, and the product includes computer executable process steps operable to control a computer to: implement a central server operable to receive data from a user via a proxy server implemented at the user for coupling to a user web browser, and from an entity that generates content, and to control information received by the user web browser via the Internet, as a function of the data from the user and from the entity that generates content.

According to a feature of the fifth exemplary embodiment of the present invention, the control of information relates to information received from a search engine or to modification of content of a web site maintained by the entity that generates content.

In a sixth exemplary embodiment of the present invention, a proxy server comprising a computer program product is provided. According to a feature of the present invention, the computer program product is disposed on a computer readable media, and the product includes computer executable process steps operable to control a computer to: implement a proxy server operable to receive a rule protocol for assisting a user web browser by acquiring data relevant to the user and transmitting the data to a central server, the data being arranged for controlling information received by the web browser via the Internet, according to instructions caused by an entity that generates content related to the data.

According to the present invention a computer readable media is contemplated as being any product that embodies information usable in a computer to execute the process steps of the present invention, including, for example, information written on a compact disk readable by a computer, and downloaded by the computer for execution, instructions transmitted to a computer via the Internet, or instructions implemented as a hardware circuit, for example, as in an integrated circuit chip.

### BRIEF DESCRIPTION OF THE DRAWINGS

FIG. 1 is a block diagram of an Internet arrangement including a proxy server and a statistics tracking central server, according to a feature of the present invention.

FIG. 2 is a flow chart showing an Internet information content flow according to a feature of the present invention.

### DETAILED DESCRIPTION OF THE PREFERRED EMBODIMENTS

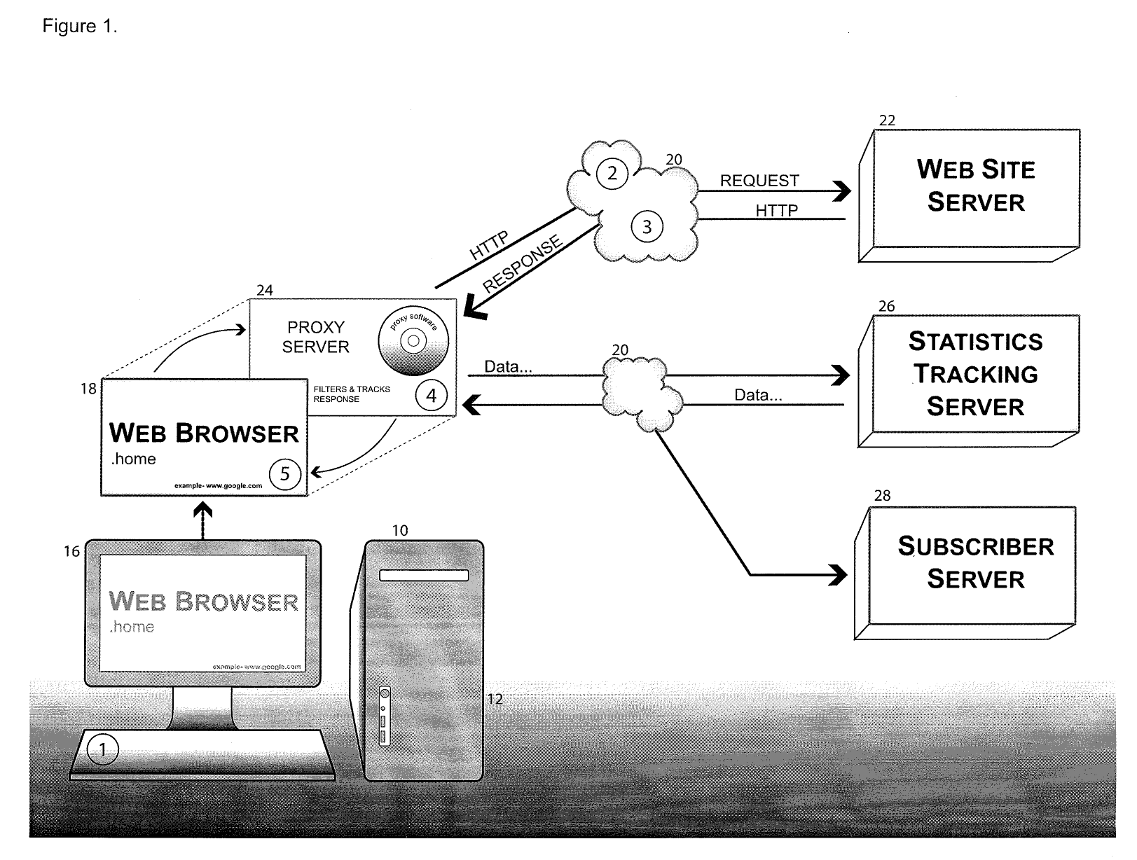

Referring now to the drawings, and initially to FIG. 1, there is shown a block diagram of an Internet arrangement including a proxy server according to a feature of the present invention. A home desk top computer system 10 includes a CPU 12, key board 14 and display screen 16, as is known in the art. A web browser 18 is loaded into the memory of the computer system 10, for execution by the CPU 12. The web browser 18 can be any commercially available web browser operable to forward requests, input by a user on the key board 14, to the Internet 20, for information from a web site 22 coupled to the Internet 20, and to receive a response to the request from the web site 22, also via the Internet 20, as is well known.

According to a feature of the present invention, a proxy server 24 is loaded into the memory of the computer system 10, for execution by the CPU 12. The proxy server 24 is arranged and configured for execution by the CPU 12 so as to operate as an interface between the web browser 18 and the Internet 24, to filter and track responses received from the Internet 24, in response to the requests forwarded by a user of the computer system 10.

For example, the proxy server 24 receives a rule protocol from a statistics tracking central server 26, via the Internet 20. The rule protocol includes a set of content filtering rules for implementation by the proxy server 24 in respect to the content of responses received by the web browser 18 from the Internet 20. The content filtering rules of the rule protocol are set according to instructions based upon data relevant to the user, and information provided by an entity that generates content related to the information contained in a response received via the Internet 20 by the web browser 18, as will be described.

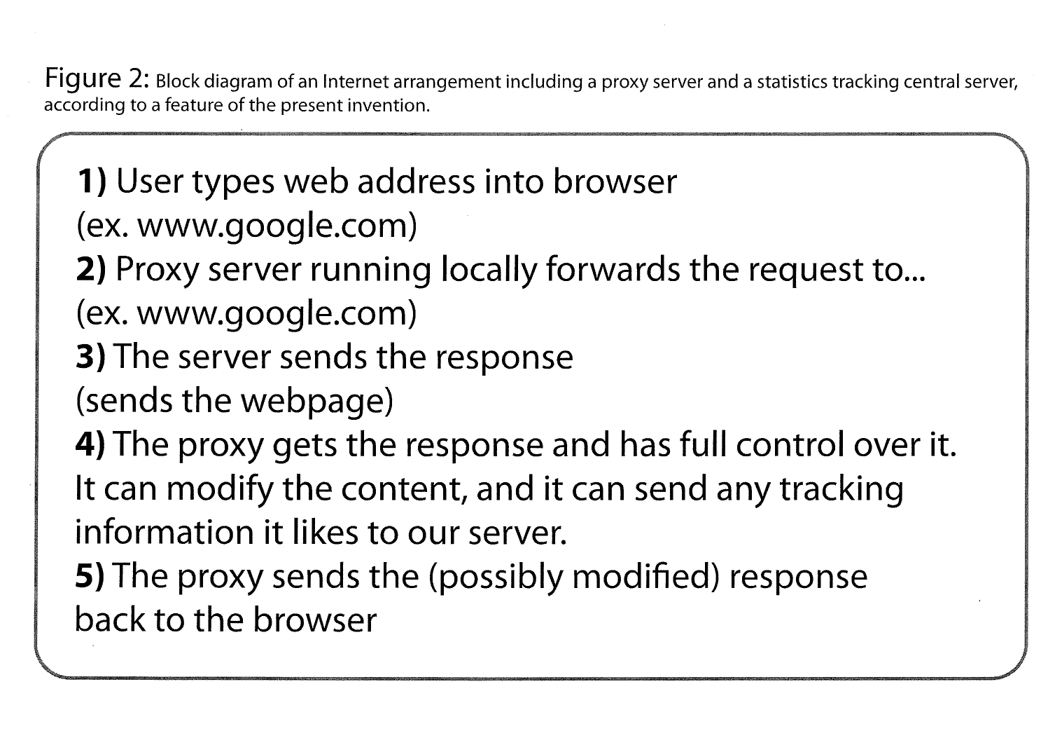

FIG. 2 shows a flow chart depicting an Internet information content flow according to a feature of the present invention. The number of each step is also indicated in FIG. 1, on the component of the Internet arrangement implementing the corresponding step. In step 1, a user types a web address into the web browser 18, via the key board 14, for example, the address for a search engine such as google.com. In step 2, the web browser 18 forwards the address to the proxy server 24, which, in turn, forwards the requested address over the Internet 20.

As is well known, the Internet 20 operates to locate a web site server 22 corresponding to the web address, and forwards the user's request to the web site server 22. In step 3, the web site server 22 responds to the request and sends a response to the web address of the computer system 10, via the Internet 20.

According to a feature of the present invention, the response from the web site server is received by the proxy server 24 (step 4). The proxy server then reviews and modifies the content of the response according to the content filtering rules of the rule protocol received from the statistics tracking central server 26, as described above. In step 5, the proxy server 24 sends the modified response to the web browser 18, that then operates to display the modified response on the display screen 16. The rule protocol can be implemented using HTML instructions.

Pursuant to another feature of the present invention, the statistics tracking central server 26 operates as a central service center to content providers such as newspaper and magazine publishers. Newspaper and magazine publishers subscribe to the central service center, and each subscriber provides to the service center information on the nature of the content of interest to the subscriber, for example, general news, sports, fashion, travel and so on. Each subscriber can also provide to the service center information such as sponsored links and advertisements that are to be distributed to users expressing an interest in the content of the subscriber.

Each subscriber can also maintain a subscriber server 28 that includes a web site for the subscriber, that can be accessed by a user via the Internet 20. The subscriber server 28 selectively communicates with web browser 18 of the user and the statistics tracking central server 26 via the Internet 20, as shown in FIG. 1. The subscriber then communicates information about the content on the web site to the statistics tracking central server 26.

Accordingly, the service center can generate rule protocols relevant to each subscriber and each individual user. For example, the service center can generate rules relevant to the identification of interests of a user, and the modification of a response according to those identified interests, with, for example, sponsored links and/or advertisements provided by a subscriber when the subscriber's content is related to subject matter relevant to the identified interests of the user.

To that end, according to another feature of the present invention, the proxy server 24 is arranged and configured to acquire and transmit to the statistics tracking central server 26, data relevant to a user's interests, demographics, the subject matter of requests sent by the user, information on the user's hardware, the operating system and software programs installed on the user's hardware, the user's IP address, and so on. The nature of the data to be transmitted to the central server 26 by the proxy server 24 is set forth in the rule protocol. The service center can then compile a data base for all users having a proxy server 24, the data base being arranged to correlate the users, statistics derived from the data relevant to the users, as transmitted to the statistics tracking central server 26 by proxy servers 24 installed at computer systems 10 of users, and the content of interest to subscribers, as well as the specific content of web sites maintained by the subscribers, as provided by the subscribers.

A rule protocol can be prepared by the service center for a specified user, based upon the data base, and then transmitted to the proxy server 24 of the user, via the Internet 20, by the central server 26. Such a rule protocol can be revised periodically as a function of changes in user data, and/or sponsored links and advertisements and other information provided by subscribers.

In an alternative embodiment of the present invention, the proxy server 24 communicates with the central server 26 upon an indication according to a rule protocol, that the user's interests are relevant to the content of a subscriber, as for example, when a response is received from the web site server 22. The central server 26 then transmits data for a modification of the response.

Thus, for example, if a user's data indicates an interest in fashion, and a search request is submitted to a search engine by that user, on a fashion related topic, the rule protocol at the proxy server 24 of that user can operate to modify a search engine response to the request, to provide sponsored links and advertisements provided by a subscriber that is a fashion magazine publisher. The statistics tracking central server 26 can provide the sponsored links and advertisements on behalf of a content provider. In this manner, a content provider, such as a newspaper or magazine publisher, is able to distribute information to users that have an interest in the information, and can also benefit from revenues for sponsored links and advertisements.

According to yet another feature of the present invention, the statistics tracking central server 26 includes in the rule protocol for a user, a list of subscriber web site addresses. When the user inputs the address of a subscriber web site to the web browser 18, via the keyboard 14, the proxy server 24 responds by alerting the statistics tracking central server 26 that the user is about to connect to a subscriber's web site. The statistics tracking central server 26 responds by transmitting information, such as advertisements, to dedicated pages of the subscriber web site, for viewing by the user when the subscriber web site responds to the web browser 18 of the user. The transmitted information is determined as a function of the content of the subscriber web site and the user data provided by the proxy server 24 of the user, as arranged in the data base maintained by the service center.

As an alternative, the statistics tracking central server 26 can communicate information on users that it obtains from the proxy servers 24 of the users, to the subscribers. A subscriber can then either modify the content of a web site maintained by the subscriber, when access is sought by a user for whom the subscriber has information, as a function of that information, or contact the statistics tracking central server 26 when such access is sought, for information to use as a modification of content.

In a further exemplary embodiment of the present invention, the proxy server 24 can be operated to modify content received from a web site maintained by a subscriber, according to a rule protocol that identifies responses from such web sites.

According to another feature of the present invention, the service center charges service fees to the subscribers for maintaining the user interest data base, and generating and transmitting information on behalf of the subscribers.

Moreover, the rule protocol can include additional rules that permit the user to access special features on web sites maintained by subscribers.

The following provides an example of pseudo-code for each of the proxy server 24 and the statistics tracking central server 26, to illustrate an exemplary implementation of those components:

### On the Proxy Server:

```
/**
* Periodically checks with the central server for any new
* rules to apply.
*/
function periodicallyCheckForNewRules||{
    ask the central server for any rule updates every 20 minutes.
}
/**
* The proxy server intercepts all HTTP requests from the users
* browser and forwards them to the associated web site. Along
* the way, it also notifles the central tracking server the user
* has visited this page.
*/
function processRequest|string httpRequest| {
    notify the central tracking server the user has visited this page
    send the request along to the intended web site.
}
/**
  * The proxy server filters the HTTP response coming from
  * the Internet prior to sending it along to the user's browser.
  */
function filterResponse|String httpResponse| {
    // Apply custom rules depending on the web site and user.
    if |response is from nytimes.com| {
        if |the user is male| {
            if |the user is over 21| {
                if |the user has recently shopped for a valentine's day
gift| {
                    if |the user is high income| {
                        show ad for diamonds or a new car
                        get the ad itself from our central ad server
                    }
                    else if |user has disposable income| {
                        swap in ad for romantic moonlight sail.
                        get the ad itself from our central ad server
                    }
                }
            }
        } else {
        }
    }
    else if |response is from Amazon.com| {
    }
    ....
    send the modified response back to the user's browser
}
```

### Statistics Tracking Central Server

```
/**
* Processes data coming in from a user notifying us they've
* visited a particular page. This could be the result of
* clicking on an add, and we'll record that as well.
*/
function receiveRequestData|String user, String wabPageUrl| {
    record the web page they visited in our database.
}
/**
* Retreives the latest rules to use for a specific user.
*/
function getNewRules|String user| {
    return the new rules.
}
/**
* The tracking server will continually mine through all of
* its date to optimize ad targeting.
*/
function processData|| {
    continually run through all web sites we know users have
    visited and look for ad optimizations based on what ads
    users have clicked on, their demographics, etc.
}
```

The following provides an example of data stored in the data base maintained by the service center:

### Data

Some of the user data will be based on statistical correlations, We won't always know 100% that user X is male, for example, but we might be able to predict the sex of user X with 90% probability.

### User:

Sex and probability factor
Age and probability factor
Income and probability factor
Ethnicity and probability factor
Name
Address
Language
Locale
All Purchases
Ads clicked on
Ads ignored
Computer operating system
Computer CPU
Computer memory
Computer name
IP address

### Visits:

Web site URL
Time of visit
User

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A computer program product, disposed on a computer readable media, the product including computer executable process steps operable to control a computer to: implement a proxy server operable to receive a rule protocol for modification of information received via the Internet, according to instructions caused by an entity that generates content related to the information, and to modify content by the proxy server, of information received via the Internet, according to the rule protocol.

2. The computer program product of claim 1 wherein the modification of content includes sponsored link information.

3. The computer program product of claim 1 wherein the modification of content includes advertisements.

4. A computer program product, disposed on a computer readable media, the product including computer executable process steps operable to control a computer to: implement a proxy server operable to receive a rule protocol for assisting a user web browser by controlling information received by the web browser via the Internet, according to instructions caused by an entity that generates content related to the information.

5. The computer program product of claim 4 wherein the process step of controlling information received by the web browser via the Internet, according to instructions caused by an entity that generates content related to the information, is executed by modifying content of information received via the Internet, according to a rule protocol based upon user data and information related to the entity that generates content.

6. The computer program product of claim 4 wherein the process step of controlling information received by the web browser via the Internet, according to instructions caused by an entity that generates content related to the information, is executed by transmitting information to a central server regarding an attempt by the user web browser to connect to a web site maintained by the entity that generates content, to cause a modification of the content of the web site as a function of user data and information related to the entity that generates content.

7. A computer program product, disposed on a computer readable media, the product including computer executable process steps operable to control a computer to: cause content of a web site maintained by an entity that generates content, to be modified as a function of information based upon user data and information related to the entity that generates content, the computer readable media being adapted for execution in connection with a web browser of an individual user.
